(19) United States
(12) Patent Application Publication
(10) Pub. No.: US 2023/0346035 A1
(43) Pub. Date: Nov. 2, 2023

(54) VAPORIZER AND ELECTRONIC VAPORIZATION APPARATUS

(71) Applicant: SHENZHEN SMOORE TECHNOLOGY LIMITED, Shenzhen (CN)

(72) Inventors: Hongming ZHOU, Shenzhen (CN); Wenli DU, Shenzhen (CN); Ke WAN, Shenzhen (CN); Hai ZHAO, Shenzhen (CN)

(21) Appl. No.: 18/350,689

(22) Filed: Jul. 11, 2023

Related U.S. Application Data
(63) Continuation of application No. PCT/CN2022/070412, filed on Jan. 6, 2022.

(30) Foreign Application Priority Data
Jan. 26, 2021 (CN) 202120219542.3

(51) Int. Cl. A24F 40/48; A24F 40/10; A24F 40/46; H05B 3/26

(52) U.S. Cl. CPC A24F 40/48; A24F 40/10; A24F 40/46; H05B 3/26

(57) ABSTRACT

A vaporizer includes a base assembly and a vaporization core. The base assembly is provided with an air inlet channel in communication with the outside. The vaporization core forms a vaporization cavity and is configured to communicate with the air inlet channel of the base assembly. The vaporization core has a vaporization surface configured to vaporize a vaporization medium and define a part of a boundary of the vaporization cavity. A tangent of the air inlet channel at a connection point in communication with the vaporization cavity and a tangent of the vaporization surface form an acute angle.

### CROSS-REFERENCE TO RELATED APPLICATIONS

This application is a continuation of International Application No. PCT/CN2022/070412, filed on Jan. 6, 2022, which claims priority to Chinese Patent Application No. 202120219542.3, filed on Jan. 26, 2021. The disclosure of both of the aforementioned applications are hereby incorporated by reference in their entireties.

### TECHNICAL FIELD

This application relates to the field of vaporization technologies, and in particular, to a vaporizer and an electronic vaporization apparatus that includes the vaporizer.

### BACKGROUND

An electronic vaporization apparatus generally includes a vaporizer and a power supply, where the power supply supplies power to the vaporizer, the vaporizer converts electrical energy into heat energy, and an aerosol-generating substrate is converted by the heat energy into an aerosol that can be inhaled by a user. For a conventional vaporizer, a large amount of aerosol remaining in a vaporization cavity of the vaporizer is converted into condensate, and the condensate leaks from the bottom of the vaporizer to form leakage liquid, and the leakage liquid enters the power supply to erode the power supply and even cause explosion of the power supply, thereby affecting service life and safety of the power supply. In addition, the actual amount of aerosol inhaled by the user is reduced due to residual aerosol in the vaporization cavity.

### SUMMARY

According to various exemplary embodiments of this application, a vaporizer and an electronic vaporization apparatus that includes the vaporizer are provided.

An electronic vaporization apparatus, including:
a base assembly, provided with an air inlet channel in communication with the outside; and
a vaporization core, forming a vaporization cavity, communicating with the air inlet channel, with the base assembly, wherein the vaporization core has a vaporization surface configured to vaporize a vaporization medium and define a part of boundary of the vaporization cavity, and the angle between the tangent of the air inlet channel at a connection point in communication with the vaporization cavity and the tangent of the vaporization surface is acute.

In an embodiment, the central axis of the air inlet channel is parallel or coincident with the central axis of the vaporizer, and the vaporization surface is planar and at an acute angle to the central axis of the vaporizer.

In an embodiment, the acute angle between the vaporization surface and the central axis of the vaporizer ranges from 30° to 60°.

In an embodiment, the base assembly has a flow guide surface spaced apart from the vaporization surface and defining a part of boundary of the vaporization cavity, and the flow guide surface is parallel to the vaporization surface.

In an embodiment, the tangent of the air inlet channel at the connection point in communication with the vaporization cavity is parallel to the extension direction of the air inlet channel.

In an embodiment, the vaporization core comprises a substrate, a heating body, a first electrode body, and a second electrode body, the vaporization surface is located on the substrate, the heating body, the first electrode body, and the second electrode body are all disposed on the vaporization surface, the vaporization cavity has an outlet for a gas to flow out, and both the first electrode body and the second electrode body are electrically connected to the heating body and disposed close to the end of the vaporization surface far from the outlet.

In an embodiment, the heating body comprises a curved section and two straight sections disposed in parallel, the curved section is connected to the end of the straight section close to the outlet, the first electrode body and the second electrode body are respectively connected to the ends of the two straight sections far from the outlet, and the orthographic projection of the air inlet channel on the vaporization surface is located between the curved section and the first and second electrode bodies.

In an embodiment, the base assembly has an abutting surface, and the edge of the vaporization surface abuts against the abutting surface.

In an embodiment, the vaporizer further comprises a housing, wherein both the vaporization core and the base assembly are connected to the housing, the housing is provided with an inhalation channel for aerosol output and communicating with the vaporization cavity, and the flow direction of gas in the inhalation channel is at an acute angle to the flow direction of gas in the vaporization cavity.

In an embodiment, the inhalation channel comprises a first suction section and a second suction section that are in communication with each other, the length of the second suction section is greater than three times the length of the first suction section, the first suction section is in communication with the outside and the central axis of the first suction section coincides with the central axis of the vaporizer, and the second suction section is in communication with the vaporization cavity and the central axis of the second suction section is spaced apart from the central axis of the vaporizer.

In an embodiment, the central axis of the second suction section has a curved portion and a vertical portion that are connected to each other, the vertical portion is parallel to the central axis of the vaporizer, and the curved portion is disposed at an angle to the central axis of the vaporizer.

An electronic vaporization apparatus, comprising a power supply and the vaporizer according to any one of the foregoing embodiments, wherein the vaporizer is connected to the power supply.

A technical effect of an embodiment of this application is as follows: Because the angle between the tangent of the air inlet channel at the connection point in communication with the vaporization cavity and the tangent of the vaporization surface is acute, the direction in which the gas flows into the vaporization cavity from the air inlet channel is an acute angle with the direction in which the gas flows in the vaporization cavity. Therefore, a relatively large direction deflection of the air flow entering the vaporization cavity from the air inlet channel is avoided, and a vortex is reduced in the air flow in the vaporization cavity. In this way, a kinetic energy loss of the air flow can be reduced, so that the air flow in the vaporization cavity has a relatively large flow rate. This ensures that the air flow quickly carries the aerosol to leave the vaporization cavity, and reduces the stagnation amount and the stagnation time of the aerosol in the vaporization cavity, thereby reducing condensate generated in the vaporization cavity. In view of the decrease of the condensate, the leakage liquid formed by leakage of the condensate from the air inlet channel to the outside of the vaporizer can be reduced, thereby reducing generation of the leakage liquid. In addition, the aerosol discharged into the vaporization cavity can be absorbed by the user as much as possible, to increase the effective absorption amount of the aerosol in a unit time.

### BRIEF DESCRIPTION OF THE DRAWINGS

To describe the technical solutions in embodiments of this application or the conventional technology more clearly, the following briefly describes the accompanying drawings required for describing the embodiments or the conventional technology. Apparently, the accompanying drawings in the following description show only some embodiments of this application, and a person of ordinary skill in the art may still derive other accompanying drawings from the accompanying drawings without creative efforts.

FIG. 1 is a schematic diagram of a three-dimensional structure of an electronic vaporization apparatus according to an embodiment;

FIG. 2 is a schematic diagram of a three-dimensional structure of a vaporizer in the electronic vaporization apparatus shown in FIG. 1;

FIG. 3 is a schematic diagram of a planar sectional structure of the vaporizer shown in FIG. 2;

FIG. 4 is a schematic diagram of a three-dimensional sectional structure of the vaporizer shown in FIG. 2;

FIG. 5 is a schematic structural diagram of FIG. 4 from another perspective;

FIG. 6 is a schematic diagram of a partially exploded three-dimensional sectional structure of the vaporizer shown in FIG. 2;

FIG. 7 is a schematic structural diagram of a longitudinal planar section in an assembled state in FIG. 6; and

FIG. 8 is a schematic diagram of a three-dimensional structure of a vaporization core in the vaporizer shown in FIG. 2.

### DETAILED DESCRIPTION

To facilitate understanding of this application, the following describes this application more comprehensively with reference to related accompanying drawings.

A preferred implementation of this application is provided in the accompanying drawings. However, this application may be implemented in many different forms, and is not limited to the implementations described in this specification. On the contrary, the implementations are provided to make understanding of the disclosed content of this application more comprehensive.

It should be noted that, when an element is referred to as “being fixed to” another element, the element may be directly on the another element, or an intermediate element may be present. When an element is considered to be “connected to” another element, the element may be directly connected to the another element, or an intervening element may be present. The terms “inner”, “outer”, “left”, “right”, and similar expressions used in this specification are only for purposes of illustration but not indicate a unique implementation.

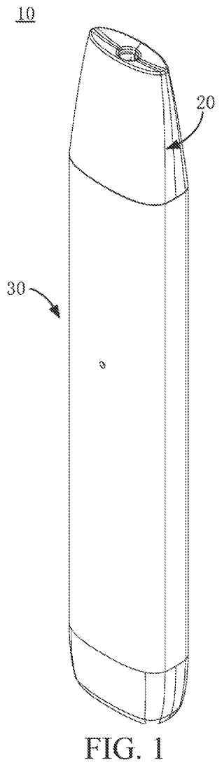

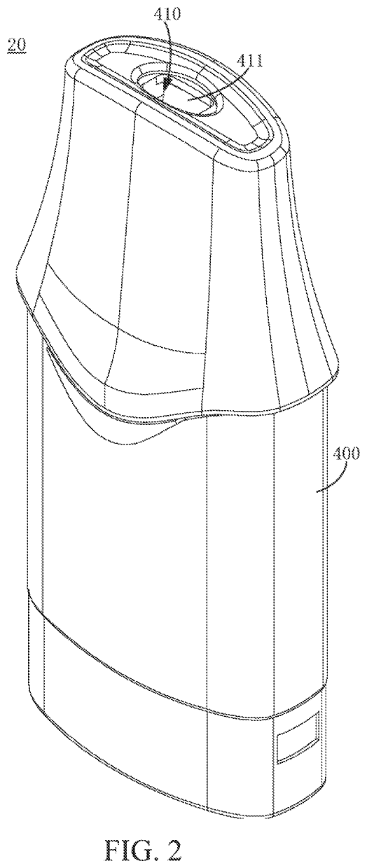

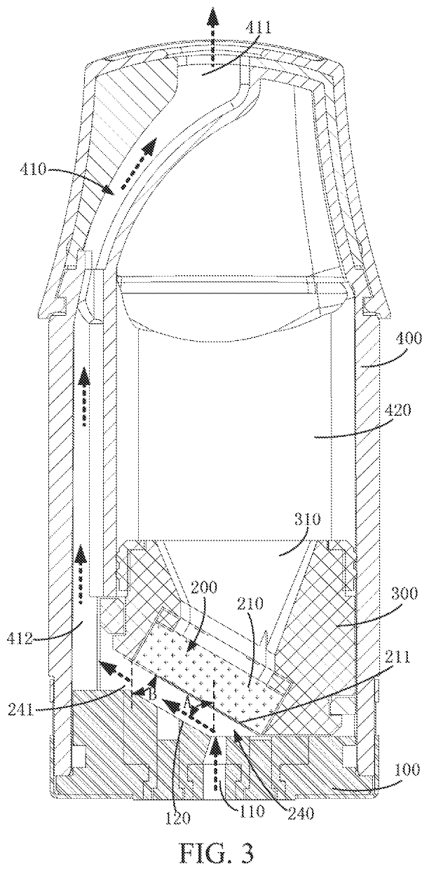

Referring to FIG. 1, FIG. 2, and FIG. 3, an electronic vaporization apparatus 10 provided in an embodiment of this application includes a vaporizer 20 and a power supply 30. The vaporizer 20 may form a detachable connection relationship with the power supply 30. The power supply 30 supplies power to the vaporizer 20. The vaporizer 20 converts electrical energy into thermal energy, and a vaporization medium is vaporized into an aerosol that can be inhaled by a user under the effect of thermal energy. The vaporization medium may be an aerosol-generating substrate such as an oil liquid. The vaporizer 20 includes a base assembly 100, a vaporization core 200, a top cover assembly 300, and a housing 400. Both the top cover assembly 300 and the vaporization core 200 are disposed in the housing 400, and at least a part of the base assembly 100 is accommodated in the housing 400. A liquid storage cavity 420 is formed between the top cover assembly 300 and the housing 400, and the liquid storage cavity 420 is configured to store a liquid vaporization medium. A liquid discharge channel 310 is disposed on the top cover assembly 300, the liquid discharge channel 310 communicates with the liquid storage cavity 420, the vaporization core 200 is disposed on the top cover assembly 300, and the vaporization medium in the liquid storage cavity 420 flows into the vaporization core 200 by using the liquid discharge channel 310, so that the vaporization core 200 vaporizes the vaporization medium to form an aerosol.

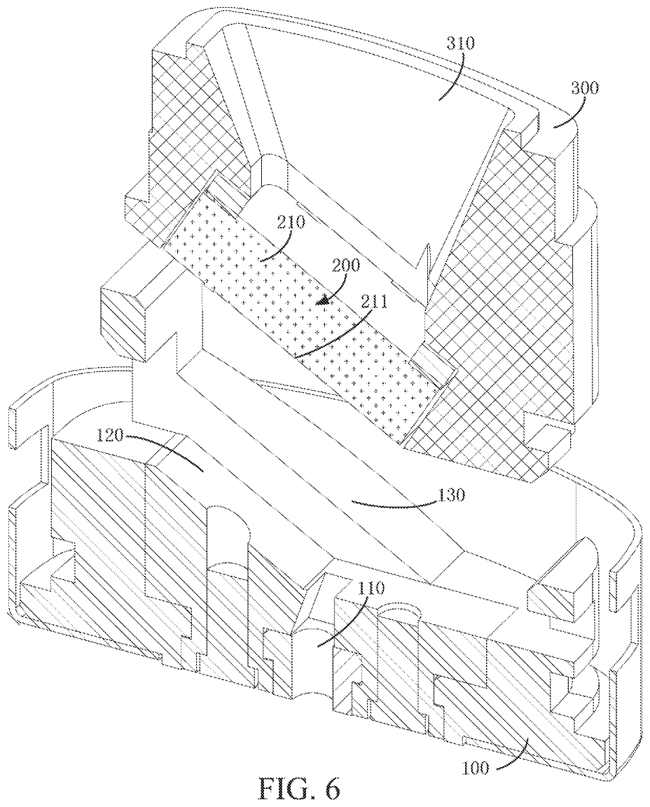

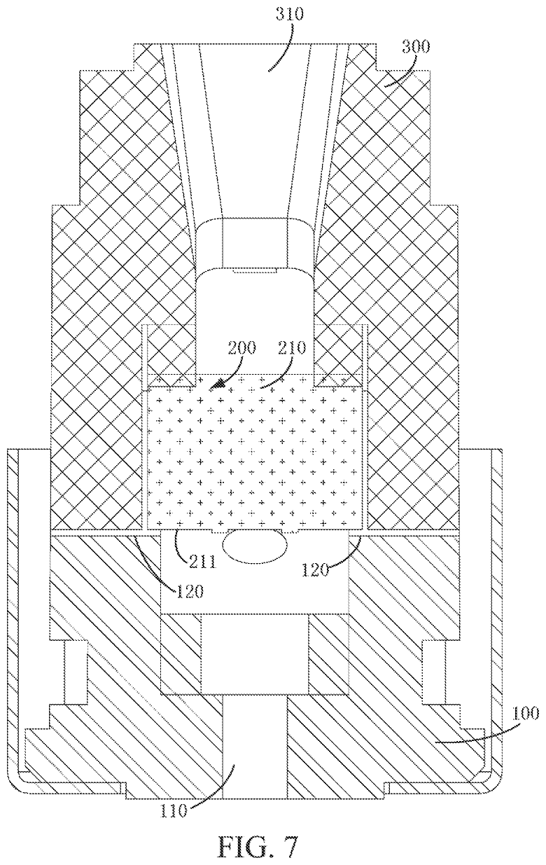

In some embodiments, an air inlet channel 110 is provided on the base assembly 100. When the user inhales, an external gas first enters the inside of the vaporizer 20 through the air inlet channel 110. The air inlet channel 110 may be a linear channel, for example, the central axis of the air inlet channel 110 and the central axis of the vaporizer 20 are parallel to or coincide with each other. In other words, the central axis of the air inlet channel 110 extends in the vertical direction. Both the top cover assembly 300 and the housing 400 are connected to the base assembly 100. Referring to FIG. 3, FIG. 6, and FIG. 7, an abutting surface 130 is disposed on the base assembly 100. Both the vaporization core 200 and the top cover assembly 300 can form a pressing relationship with the abutting surface 130, so that the abutting surface 130 carries and limits installation of the vaporization core 200 and the top cover assembly 300, thereby improving installation accuracy and installation efficiency.

In some embodiments, an inhalation channel 410 is disposed on the housing 400, and the aerosol is finally discharged through the inhalation channel 410 and absorbed by the user. The inhalation channel 410 includes a first suction section 411 and a second suction section 412. The first suction section 411 and the second suction section 412 are connected to each other. The first suction section 411 is connected to the outside. The user may inhale the aerosol at the end of the first suction section 411. The central axis of the first suction section 411 may be a straight line extending in the vertical direction. For example, the central axis of the first suction section 411 may coincide with the central axis of the vaporizer 20. The length of the first suction section 411 is relatively small, and the length of the second suction section 412 is relatively large. In some embodiments, the length of the second suction section 412 is greater than three times the length of the first suction section 411. The central axis of the second suction section 412 is a curve, so that the curved central axis is spaced from the central axis of the vaporizer 20 is maintained. In this embodiment, the curved central axis has a curved portion and a vertical portion that are connected to each other, the vertical portion is parallel to the central axis of the vaporizer 20, and the curved portion is disposed at an angle to the central axis of the vaporizer 20.

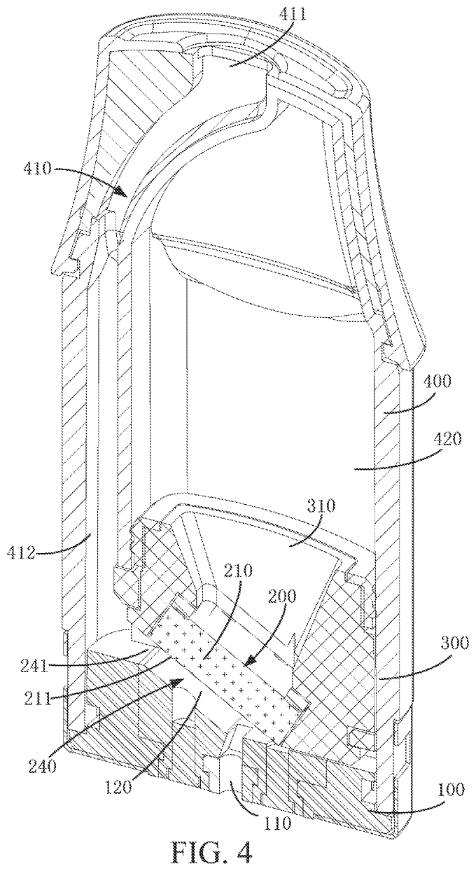

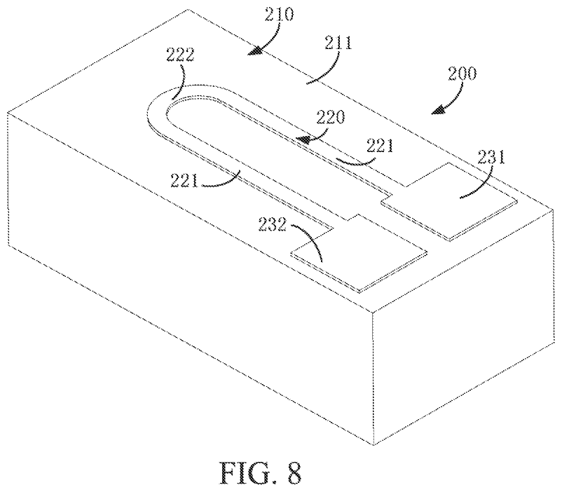

Referring to FIG. 3, FIG. 4, and FIG. 8, in some embodiments, the vaporization core 200 includes a substrate 210, a heating body 220, a first electrode body 231, and a second electrode body 232. The substrate 210 may be made of a porous ceramic material, so that a large quantity of micropores exist in the substrate 210 to form a specific porosity. By means of capillary action of the micropores, the substrate 210 can absorb the vaporization medium that flows from the liquid storage cavity 420 into the liquid discharge channel 310. Therefore, the substrate 210 can transmit and buffer the vaporization medium. A vaporization cavity 240 is formed between the substrate 210 and the base assembly 100, the substrate 210 has a vaporization surface 211, and the vaporization surface 211 defines a part of boundary of the vaporization cavity 240 and is configured to vaporize the vaporization medium. The second suction section 412 of the inhalation channel 410 is directly connected to the vaporization cavity 240, and the air inlet channel 110 is also connected to the vaporization cavity 240.

When the user inhales, the external gas enters the vaporization cavity 240 through the air inlet channel 110. The external gas carries the aerosol in the vaporization cavity 240 and successively passes through the second suction section 412 and the first suction section 411 to be absorbed by the user. Apparently, the external gas successively passes through the air inlet channel 110, the vaporization cavity 240, the second suction section 412, and the first suction section 411 to enter the oral cavity of the user. The dashed arrow in FIG. 3 represents a flow path of the gas during inhalation. The heating body 220, the first electrode body 231, and the second electrode body 232 are all disposed on the vaporization surface 211. For example, the three may be directly attached to the vaporization surface 211, or a groove is disposed on the vaporization surface 211, and the heating body 220, the first electrode body 231, and the second electrode body 232 are at least partially accommodated in the groove.

The heating body 220 may be made of metal or an alloy material, and both the first electrode body 231 and the second electrode body 232 may be made of metal or an alloy material. The resistivity of the heating body 220 may be greater than the resistivity of the first electrode body 231 and the second electrode body 232. The heating body 220, the first electrode body 231, and the second electrode body 232 are electrically connected to each other to form a series circuit. Heat generated by the heating body 220 in a unit time is far greater than heat generated by the first electrode body 231 and the second electrode body 232 in a unit time. Heat generated by the first electrode body 231 and the second electrode body 232 is extremely small and may be ignored.

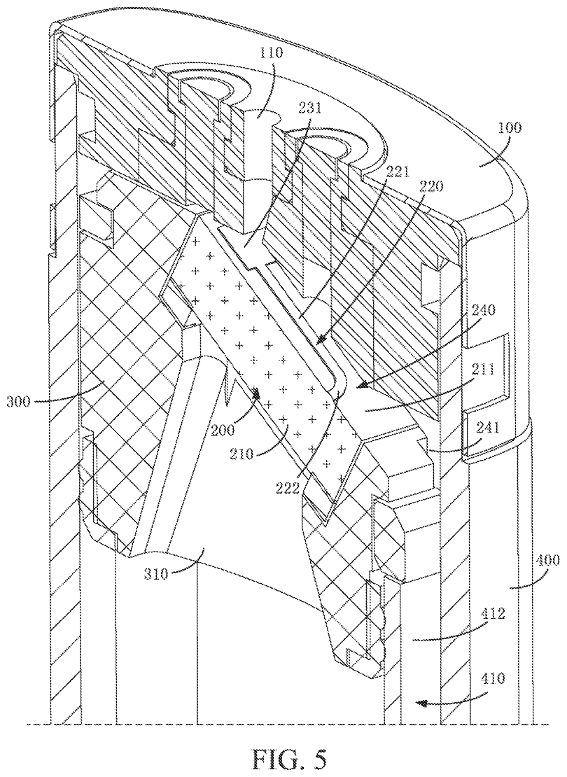

The heating body 220 includes a curved section 222 and a straight section 221. There is one curved section 222. The curved section 222 may be semi-circular arc-shaped. A quantity of straight sections 221 is two. The two straight sections 221 are disposed in parallel at intervals from each other, and ends of the two straight sections 221 are aligned with each other. The curved section 222 is connected to one ends of the two straight sections 221 at the same time, so that the entire heating body 220 is substantially U-shaped, and the first electrode body 231 and the second electrode body 232 are respectively connected to the other ends of the two straight sections 221. Certainly, the first electrode body 231 and the second electrode body 232 are respectively electrically connected to a positive electrode and a negative electrode of the power supply 30, so that the power supply 30 supplies power to the heating body 220 by using the first electrode body 231 and the second electrode body 232. When the heating body 220 generates heat, the vaporization medium soaked in the heating body 220 and the vaporization medium on the vaporization surface 211 absorb the heat for vaporization to form an aerosol, and the aerosol is first discharged into the vaporization cavity 240. Referring to FIG. 3, FIG. 4, and FIG. 5, the vaporization cavity 240 has an outlet 241 for gas to flow out of the vaporization cavity 240, and the outlet 241 is disposed near the second suction section 412. Apparently, the gas flowing out of the outlet 241 will directly enter the second suction section 412. In the direction in which the central axis of the vaporizer 20 extends, the outlet 241 is closer to the first suction section 411 than the air inlet channel 110. Generally speaking, the outlet 241 is located obliquely above the air inlet channel 110. When the user inhales at the end of the first suction section 411, the flow direction of the gas flowing into the vaporization cavity 240 from the air inlet channel 110 is at an acute angle A with the flow direction of the gas in the vaporization cavity 240. For example, the angle between the tangent of the air inlet channel 110 at the connection point in communication with the vaporization cavity 240 and the tangent of the vaporization surface 211 is the acute angle A. That is, the angle between the tangent of the inner wall surface of the air inlet channel 110 near the end of the vaporization cavity 240 and the tangent of the vaporization surface 211 is the acute angle A. In other words, the air inlet channel 110 has an end opening that directly communicates with the vaporization cavity 240 on the base assembly 100, and the normal direction of the end opening forms the acute angle A with the tangential direction of the vaporization surface 211. Specifically, the vaporization surface 211 is a plane and forms an acute angle B with the central axis of the vaporizer 20, and the acute angle B and the acute angle A may be equal. In other words, the horizontal plane perpendicular to the central axis of the vaporizer 20 is used as a reference plane, and the vaporization surface 211 is inclined relative to the reference plane, that is, the vaporization surface 211 is an inclined plane. Therefore, with the guidance of the vaporization surface 211, the direction in which the gas flows into the vaporization cavity 240 from the air inlet channel 110 may form the acute angle A with the flow direction of the gas in the vaporization cavity 240. The acute angle B formed between the vaporization surface 211 and the central axis of the vaporizer 20 ranges from 30° to 60°, and a specific value of the acute angle B may be 30°, 45°, 50°, 60°, or the like.

It may be understood that, in this implementation, the air inlet channel 110 is of a linear structure, and the tangent at the connection point between the air inlet channel 110 and the vaporization cavity 240 is actually parallel to the extension direction of the air inlet channel 110.

In another embodiment, the air inlet channel 110 may alternatively be disposed in another structure, for example, an elbow structure. An air flow enters the vaporization cavity in the tangential direction at the connection point between the air inlet channel 110 and the vaporization cavity 240, and the tangential direction is actually the direction in which the air flow flows into the vaporization cavity 240. Further, in this embodiment, the vaporization surface 211 is disposed in a planar structure, and the angle between the tangent of the air inlet channel 110 at the connection point with the vaporization cavity 240 and the tangent of the vaporization surface 211, that is, the angle between the tangent and the vaporization surface 211 at the connection point with the tangent. It may be understood that the vaporization surface 211 is a planar structure, and the tangent plane of the vaporization surface 211 is actually the vaporization surface. In another embodiment, the vaporization surface 211 may further be disposed in another structure, for example, an arc cylinder surface or a sphere surface. After being in contact with an acute angle of the vaporization surface 211, the air flow flows along the vaporization surface 211 to the outlet 241.

If the vaporization surface 211 is disposed perpendicular to the central axis of the vaporizer 20, the vaporization surface 211 is parallel to the foregoing reference plane, that is, the vaporization surface 211 is a horizontal plane that is not disposed obliquely. In this case, the gas that flows into the vaporization cavity 240 vertically upward from the air inlet channel 110 collides with the vaporization surface 211 to form a “forward collision”, and with guidance of the vaporization surface 211, the gas after the collision changes the flow direction, so that the air flow direction is deflected from the vertical direction by 90° and converted into the horizontal direction, that is, the direction in which the gas flows into the vaporization cavity 240 from the air inlet channel 110 is perpendicular to the flow direction of the gas in the vaporization cavity 240. In this way, the following adverse effects are caused: (1) The gas entering the vaporization cavity 240 “forwardly collides” with the vaporization surface 211. The deflection direction of the gas flow is relatively large (that is, deflection by 90°), so that kinetic energy loss of the gas flow is relatively large. On the one hand, the speed of the gas flow is reduced, and on the other hand, the gas flow forms a relatively large turbulence in the vaporization cavity 240, and a strong vortex is generated. In view of the reduced speed of the air flow and the formation of vortex, it is difficult for the gas to carry the aerosol to quickly exit the vaporization cavity 240 and enter the inhalation channel 410 to be absorbed by the user, so that a large amount of aerosol remains in the vaporization cavity 240 for a long time. Therefore, the concentration of the aerosol is reduced, thereby reducing an amount of aerosol actually inhaled by the user in a unit time. In addition, the aerosol remaining in the vaporization cavity 240 cools to form condensate, and the condensate further leaks out of the vaporizer 20 through the air inlet channel 110 to form leakage liquid. The leakage liquid may cause erosion to the power supply 30, thereby reducing the service life of the power supply 30, and even causing a risk of explosion of the power supply 30. (2) Because the speed of the air flow is reduced and the vortex is formed, it is difficult for the gas to take away the heat generated by the heating body 220, and as a result, the temperature of the heating body 220 is excessively high, which affects the service life thereof.

However, for the vaporizer 20 in the foregoing embodiment, because the vaporization surface 211 is obliquely disposed, the vaporization surface 211 is an oblique plane, which can effectively prevent the gas flowing into the vaporization cavity 240 vertically upward from the air inlet channel 110 from colliding with the vaporization surface 211 to form a “forward collision”, and ensure that the gas and the vaporization surface 211 form an “oblique collision”. In addition, with guidance of the vaporization surface 211, the direction in which the gas flows into the vaporization cavity 240 from the air inlet channel 110 and the flow direction of the gas in the vaporization cavity 240 form an acute angle. Therefore, after the “oblique collision,” the air flow direction is deflected from the vertical direction by less than 90° and converted into an oblique upward direction, thereby producing at least the following beneficial effects: (1) The kinetic energy loss of the air flow after the “oblique collision” is greatly reduced relative to that of the “forward collision”, so as to ensure that the air flow still maintains a relatively large flow rate. In addition, a turbulence of the air flow in the vaporization cavity 240 is reduced, and generation of the vortex is further reduced. It is ensured that the air flow with the relatively large flow rate quickly leaves the vaporization cavity 240 and enters the inhalation channel 410 to be absorbed by the user, and the stagnation amount and the stagnation time of the aerosol in the vaporization cavity 240 are greatly reduced, so as to reduce formation of the condensate and the leakage liquid, prevent erosion of the leakage liquid to the power supply 30, and improve service life and safety of the power supply 30. (2) Because the gas in the vaporization cavity 240 maintains a relatively large flow rate, the gas can quickly take away the heat generated by the heating body 220, so as to prevent the heating body 220 from being damaged due to an excessively high temperature, and improve the service life of the heating body 220. (3) Because the vaporization surface 211 is obliquely disposed, the entire vaporization core 200 may be obliquely disposed, so as to reduce the total volume of the vaporization cavity 240. Therefore, the total amount of retained aerosol accommodated in the vaporization cavity 240 can be reduced, and formation of condensate and leakage liquid can also be reduced. (4) The aerosol remaining in the vaporization cavity 240 is reduced, and the concentration and the effective absorption amount of the aerosol can be increased, that is, the acquisition amount of the aerosol by the user in a unit time can be increased.

Referring to FIG. 5, FIG. 6, and FIG. 8, in some embodiments, the curved section 222 is connected to the end of the straight section 221 close to the outlet 241, and the first electrode body 231 and the second electrode body 232 are respectively connected to the ends of the two straight sections 221 away from the outlet 241, that is, the first electrode body 231 and the second electrode body 232 are disposed close to the air inlet channel 110. Apparently, the first electrode body 231 and the second electrode body 232 are also disposed close to the end of the vaporization surface 211 away from the outlet 241, that is, the first electrode body 231 and the second electrode body 232 are disposed close to the lower end of the vaporization surface 211. The orthographic projection of the air inlet channel 110 on the vaporization surface 211 is located between the curved section 222, the first electrode body 231, and the second electrode body 232. Therefore, gas that flows vertically upward from the air inlet channel 110 into the vaporization cavity 240 is difficult to contact the first electrode body 231 and the second electrode body 232, so as to avoid turbulence caused by a collision between the gas flow and the first electrode body 231 and the second electrode body 232 and generating a vortex, prevent the speed of the gas flow from decreasing, and ensure that gas with a relatively large flow rate carries the aerosol and quickly leaves the vaporization cavity 240, which can also reduce formation of condensate and leakage liquid.

Referring to FIG. 3, in some embodiments, the base has a flow guide surface 120, the flow guide surface 120 defines a part of boundary of the vaporization cavity 240 and is located below the vaporization surface 211, and the flow guide surface 120 is disposed parallel to the vaporization surface 211. By disposing the flow guide surface 120, the space of the vaporization cavity 240 may be further compressed. For example, the volume of the vaporization cavity 240 may be compressed to less than 45 mm3, so as to reduce the total amount of retained aerosol accommodated in the vaporization cavity 240, and further reduce formation of condensate and leakage liquid. In addition, with the guiding function of the flow guide surface 120, a relatively large deflection and a vortex are prevented from being generated in the direction of an air flow that enters the vaporization cavity 240 from the air inlet channel 110, so as to avoid a kinetic energy loss caused by the deflection, further ensure that the air flow in the vaporization cavity 240 has a relatively large flow rate, and also reduce formation of condensate and leakage liquid.

Referring to FIG. 3, in some embodiments, the flow direction of the gas in the inhalation channel 410 is at an acute angle to the flow direction of the gas in the vaporization cavity 240. In this way, a direction deflection greater than or equal to 90° in the process in which the air flow flowing out of the vaporization cavity 240 flows into the inhalation channel 410 can be prevented, thereby reducing the energy loss caused by a collision between the air flow and the housing 400, so that the air flow also maintains a relatively large flow rate in the inhalation channel 410. In this way, formation of condensate and leakage liquid can also be reduced.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in this specification.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one or A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B, or C” should be interpreted as including any singular entity from the listed elements, e.g., A, any subset from the listed elements, e.g., A and B, or the entire list of elements A, B and C.

What is claimed is:

1. A vaporizer, comprising:
a base assembly, provided with an air inlet channel in communication with the outside; and
a vaporization core forming a vaporization cavity and configured to communicate with the air inlet channel of the base assembly,
wherein the vaporization core has a vaporization surface configured to vaporize a vaporization medium and define a part of a boundary of the vaporization cavity, and
wherein (i) a tangent of the air inlet channel at a connection point in communication with the vaporization cavity and (ii) a tangent of the vaporization surface form an acute angle.

2. The vaporizer of claim 1, wherein a central axis of the air inlet channel is parallel to or coincident with a central axis of the vaporizer, and wherein the vaporization surface is planar and at an acute angle to the central axis of the vaporizer.

3. The vaporizer of claim 2, wherein the acute angle between the vaporization surface and the central axis of the vaporizer ranges from 30° to 60°.

4. The vaporizer of claim 2, wherein the base assembly has a flow guide surface spaced apart from the vaporization surface and the flow guide surface defines a part of the boundary of the vaporization cavity, and the flow guide surface is parallel to the vaporization surface.

5. The vaporizer of claim 1, wherein the tangent of the air inlet channel at the connection point in communication with the vaporization cavity is parallel to an extension direction of the air inlet channel.

6. The vaporizer of claim 2, wherein the vaporization core comprises:
a substrate;
a heating body;
a first electrode body; and
a second electrode body,
wherein the vaporization surface is located on the substrate,
wherein the heating body, the first electrode body, and the second electrode body are all disposed on the vaporization surface,
wherein the vaporization cavity has an outlet for a gas to flow out, and
wherein both the first electrode body and the second electrode body are electrically connected to the heating body and disposed close to an end of the vaporization surface far from the outlet.

7. The vaporizer of claim 6, wherein the heating body comprises:
a curved section; and
two straight sections disposed in parallel,
wherein the curved section is connected to an end of the straight section close to the outlet,
wherein the first electrode body and the second electrode body are respectively connected to two ends of the two straight sections far from the outlet, and
wherein an orthographic projection of the air inlet channel on the vaporization surface is located between the curved section and the first and second electrode bodies.

8. The vaporizer of claim 2, wherein the base assembly has an abutting surface, and an edge of the vaporization surface abuts against the abutting surface.

9. The vaporizer of claim 1, further comprising a housing, wherein both the vaporization core and the base assembly are connected to the housing, the housing comprises an inhalation channel for aerosol output and configured to communicate with the vaporization cavity, and a flow direction of gas in the inhalation channel is at an acute angle to a flow direction of gas in the vaporization cavity.

10. The vaporizer of claim 9, wherein the inhalation channel comprises a first suction section and a second suction section that are in communication with each other, wherein the length of the second suction section is greater than three times the length of the first suction section, wherein the first suction section is in communication with the outside and a central axis of the first suction section coincides with a central axis of the vaporizer, and wherein the second suction section is in communication with the vaporization cavity and a central axis of the second suction section is spaced apart from the central axis of the vaporizer.

11. The vaporizer of claim 10, wherein the central axis of the second suction section has a curved portion and a vertical portion that are connected to each other, wherein the vertical portion is parallel to the central axis of the vaporizer, and wherein the curved portion is disposed at an angle to the central axis of the vaporizer.

12. An electronic vaporization apparatus, comprising:
a power supply; and
a vaporizer, comprising:
a base assembly, provided with an air inlet channel in communication with the outside; and
a vaporization core forming a vaporization cavity and configured to communicate with the air inlet channel of the base assembly,
wherein the vaporization core has a vaporization surface configured to vaporize a vaporization medium and define a part of a boundary of the vaporization cavity,
wherein (i) a tangent of the air inlet channel at a connection point in communication with the vaporization cavity and (ii) a tangent of the vaporization surface form an acute angle, and
wherein the vaporizer is connected to the power supply.
